(19) United States
(12) Patent Application Publication
(10) Pub. No.: US 2018/0026308 A1
(43) Pub. Date: Jan. 25, 2018

(54) LAYERED CELL AND METHOD OF MANUFACTURING THE SAME

(71) Applicant: TOYOTA JIDOSHA KABUSHIKI KAISHA, Toyota-shi (JP)

(72) Inventors: Keigo YAMADA, Shizuoka-ken (JP); Hiroaki NISHINO, Susono-shi (JP)

(21) Appl. No.: 15/650,220

(22) Filed: Jul. 14, 2017

(30) Foreign Application Priority Data
Jul. 25, 2016 (JP) 2016-145606

(51) Int. Cl. H01M 10/0587; H01M 4/02; H01M 10/28; H01M 2/26; H01M 10/04

(52) U.S. Cl. CPC H01M 10/0587; H01M 2/263; H01M 2/266; H01M 10/0468; H01M 10/281; H01M 10/0413; H01M 4/02

(57) ABSTRACT

A layered cell has a plurality of unit cells each having a positive electrode having a positive electrode current collector layer, a negative electrode having a negative electrode current collector layer, and a solid electrolyte layer disposed between the positive electrode and the negative electrode. The unit cells are stacked, the positive electrode current collector layer has a positive electrode current collector tab protruding from the positive electrode current collector layer in a surface direction, the negative electrode current collector layer has a negative electrode current collector tab protruding from the negative electrode current collector layer in the surface direction, and at least one of the positive electrode current collector tabs and the negative electrode current collector tabs are electrically connected and integrated with intervention of a conductive member disposed in a gap between the neighboring current collector tabs of the unit cell.

### INCORPORATION BY REFERENCE

The disclosure of Japanese Patent Application No. 2016-145606 filed on Jul. 25, 2016 including the specification, drawings and abstract is incorporated herein by reference in its entirety.

### BACKGROUND

### 1. Technical Field

The present disclosure relates to a layered cell and a method of manufacturing the same.

### 2. Description of Related Art

For example, a technology in which a plurality of unit cells are stacked to form a layered cell in order to obtain a cell having a desired voltage and capacity is known.

In the layered cell, current generated in the cell is collected by electrically connecting positive electrodes of unit cells and electrically connecting negative electrodes of unit cells, and extracted to the outside via a tab lead and used.

When the electrodes in the layered cell are electrically connected to collect current, it is usual to collect current collector tabs protruding from current collector layers and bundle them, and then connect them to the tab lead. In this case, in the current collector tabs disposed at a position far from a position at which the current collector tabs are bundled, the current collector tabs are folded at an acute angle due to bundling the current collector tabs. FIG. 1 shows a schematic view for describing a problem that may occur due to folding of the current collector tabs when the current collector tabs are bundled.

A layered cell of FIG. 1 is a layered cell obtained by alternately stacking first laminated bodies 10 formed by stacking first active material layers and solid electrolyte layers in sequence on both surfaces of a first current collector layer 11, and second laminated bodies 20 formed by stacking second active material layers on both surfaces of a second current collector layer. In the cell, first electrodes and second electrodes serving as counter electrodes of the first electrodes are stacked with intervention of the solid electrolyte layers. However, for simplicity of description, the first active material layers and the solid electrolyte layers are unified to be designated by reference numeral 15, and illustration of a layer configuration of the second laminated body 20 will be omitted.

In the layered cell of FIG. 1, the first current collector layer 11 has a current collector tab 12 protruding from the first current collector layer 11. When the current collector tabs are bundled, the current collector tabs 12 disposed at a position far from the position at which the current collector tabs are bundled are folded at, for example, a point A, to be unified at a bundling section 13, and joined to a tab lead 40 with intervention of a joining member 41. For example, cutting b of the current collector tabs 12, falling out c of components of an active material layer in the active material end portion, or the like, may occur due to folding of the current collector tabs 12 at the point a, and cause a decrease in productivity of the layered cell.

As a technology of electrically connecting positive electrodes or negative electrodes of unit cells without bundling current collector tabs, for example, Japanese Patent Application Publication No. 2001-93508 (JP 2001-93508 A) is known. JP 2001-93508 A discloses that, in a secondary cell configured to accommodate an electrode plate group in which positive electrode plates and negative electrode plates are stacked with intervention of separators in a battery container having a rectangular parallelepiped shape, protrusions protruding from opposite side edge portions of the positive electrode plates (positive electrode current collector layers) and the negative electrode plates (negative electrode current collector layers) are used as lead sections. According to the technology of JP 2001-93508 A, it is disclosed that a cell output of a layered cell is able to be improved by reducing internal resistance, thereby enabling design of a compact apparatus.

### SUMMARY

However, according to the technology of JP 2001-93508 A, since the lead sections protruding from side surfaces of the positive electrode plate and the negative electrode plate are joined to current extracting tab leads formed of parts separated from the plates, when the lead section is thin, high adhesion strength cannot be maintained between the tab leads, and problems may occur in stability during long-term use.

The present disclosure provides a layered cell having a current collecting structure having high strength adhesion between the current collector tab and the tab lead while electrically connecting positive electrodes or negative electrodes of unit cells without bundling current collector tabs that may cause cutting of the current collector layer, falling of components of an active material layer in an active material end portion, or the like, and a method of manufacturing the same.

A first aspect of the present disclosure relates to a layered cell including: a plurality of unit cells each having a positive electrode having a positive electrode current collector layer, a negative electrode having a negative electrode current collector layer, and a solid electrolyte layer disposed between the positive electrode and the negative electrode, wherein the unit cells are stacked, the positive electrode current collector layer has a positive electrode current collector tab protruding from the positive electrode current collector layer in a surface direction of the positive electrode current collector layer, the negative electrode current collector layer has a negative electrode current collector tab protruding from the negative electrode current collector layer in a surface direction of the negative electrode current collector layer, and a current collector tab that is at least one of the positive electrode current collector tab and the negative electrode current collector tab is electrically connected and integrated with the corresponding current collector tab of the neighboring unit cell with intervention of a conductive member disposed in a gap between the current collector tab and the corresponding current collector tab of the neighboring unit cell.

In the first aspect of the present disclosure, a width of the conductive member in a direction perpendicular to a direction in which the current collector tab protrudes and a direction in which the unit cells are stacked may be larger than a width of the current collector tab in the direction perpendicular to the direction in which the current collector tab protrudes and the direction in which the unit cells are stacked.

In the first aspect of the present disclosure, the layered cell may further include a lead joined to a portion of the conductive member protruding from the current collector tab.

In the first aspect of the present disclosure, each of both the positive electrode current collector tab and the negative electrode current collector tab is the current collector tab.

In the first aspect of the present disclosure, a length of the conductive member in a direction in which the current collector tab protrudes may be smaller than a length of the current collector tab in the direction in which the current collector tab protrudes.

In the first aspect of the present disclosure, the layered cell may further include an insulating member disposed on a surface of the current collector tab and disposed between the conductive member and the unit cell.

A second aspect of the present disclosure relates to a method of manufacturing the layered cell. The second aspect of the present disclosure includes preparing the positive electrode, the negative electrode and the solid electrolyte layer; joining the conductive member to one surface of the current collector tab that is at least one of the positive electrode current collector tab and the negative electrode current collector tab; stacking the positive electrode, the solid electrolyte layer and the negative electrode, and obtaining a cell laminated body formed by stacking the plurality of unit cells each having the positive electrode, the negative electrode, and the solid electrolyte layer disposed between the positive electrode and the negative electrode; and joining the conductive member and the current collector tab adjacent to the conductive member and integrally connecting and integrating the current collector tab with the corresponding current collector tab of the neighboring unit cell with intervention of the conductive member.

A third aspect of the present disclosure relates to a method of manufacturing the layered cell. The third aspect of the present disclosure includes preparing the positive electrode, the negative electrode and the solid electrolyte layer; joining the conductive members to both surfaces of the current collector tab that is at least one of the positive electrode current collector tab and the negative electrode current collector tab; stacking the positive electrode, the solid electrolyte layer and the negative electrode and obtaining a cell laminated body formed by stacking the plurality of unit cells each having the positive electrode, the negative electrode, and the solid electrolyte layer disposed between the positive electrode and the negative electrode; and joining neighboring conductive members and electrically connecting and integrating the current collector tab with the corresponding current collector tab of the neighboring unit cell with intervention of the conductive member.

In the second and third aspects of the present disclosure, joining of the current collector tab and the conductive member may be performed by ultrasonic joining.

A fourth aspect of the present disclosure relates to a method of manufacturing the layered cell. The fourth aspect of the present disclosure includes preparing the positive electrode, the negative electrode and the solid electrolyte layer; stacking the positive electrode, the solid electrolyte layer and the negative electrode and obtaining a cell laminated body formed by stacking the plurality of unit cells each having the positive electrode, the negative electrode, and the solid electrolyte layer disposed between the positive electrode and the negative electrode; disposing the conductive member in the gap between the current collector tab that is at least one of the positive electrode current collector tab and the negative electrode current collector tab and the corresponding current collector tab of the neighboring unit cell; and electrically connecting and integrating the current collector tab with the corresponding current collector tab of the neighboring unit cell with intervention of the conductive member.

Since the layered cell of the first aspect of the present disclosure does not require the current collecting structure configured to bundle the current collector tabs, cutting of the current collector layer, falling of components of the active material layer in the active material end portion, or the like, can be prevented, and thus, productivity of the cells can be improved. In addition, in the layered cell of the first aspect of the present disclosure, since adhesion strength between the current collector tab and the tab lead can be increased regardless of the thickness of the current collector layer, operational stability during long-term use is excellent.

According to the method of manufacturing the layered cell of the second to fourth aspects of the present disclosure, the layered cell of the present disclosure having the above-mentioned advantages can be easily manufactured.

### BRIEF DESCRIPTION OF THE DRAWINGS

Features, advantages, and technical and industrial significance of exemplary embodiments will be described below with reference to the accompanying drawings, in which like numerals denote like components, and wherein:

FIG. 1 is a conceptual view for describing factors decreasing productivity of a current collecting structure configured to bundle current collector tabs;

FIG. 2A is a conceptual view for describing an example of a layered cell of an embodiment, showing a front schematic view of the layered cell;

FIG. 2B is a side schematic view of the cell of FIG. 2A when seen from a rightward direction in the drawing;

FIG. 3A is a schematic view for describing an aspect of the case in which a tab lead is joined to the layered cell of FIGS. 2A and 2B;

FIG. 3B is a schematic view for describing an aspect of the case in which a tab lead is joined to the layered cell of FIGS. 2A and 2B;

FIG. 3C is a schematic view for describing an aspect of the case in which a tab lead is joined to the layered cell of FIGS. 2A and 2B;

FIG. 4A is a schematic plan view for describing the layered cell when a width of a, conductive member is larger than that of a current collector tab, showing a plan schematic view in a stacking direction of unit cells;

FIG. 4B is a partially enlarged perspective view of an example of an aspect in which the tab lead is joined to the layered cell of FIG. 4A;

FIG. 5A is a schematic side view of an example of the case in which the layered cell of the embodiment has an insulating member in a direction perpendicular to a stacking direction of the unit cells;

FIG. 5B is a schematic plan view of an example of the case in which the layered cell of the embodiment has the insulating member in the stacking direction;

FIG. 6 is a schematic view for describing an example of an electrode obtained in a process (1) in a first manufacturing method serving as an example of a method of manufacturing a layered cell of the embodiment;

FIG. 7 is a schematic view for describing an example of a process (2-1) in the first manufacturing method serving as an example of a method of manufacturing a layered cell of the embodiment;

FIG. 8 is a schematic view for describing a shearing process after a process (2); FIG. 9 is a schematic view for describing an example of a process (3) in the first manufacturing method serving as an example of a method of manufacturing a layered cell of the embodiment; and

FIG. 10 is a schematic view for describing a process of disposing a conductive member in a gap between current collector tabs in another method of the method of manufacturing the layered cell of the embodiment.

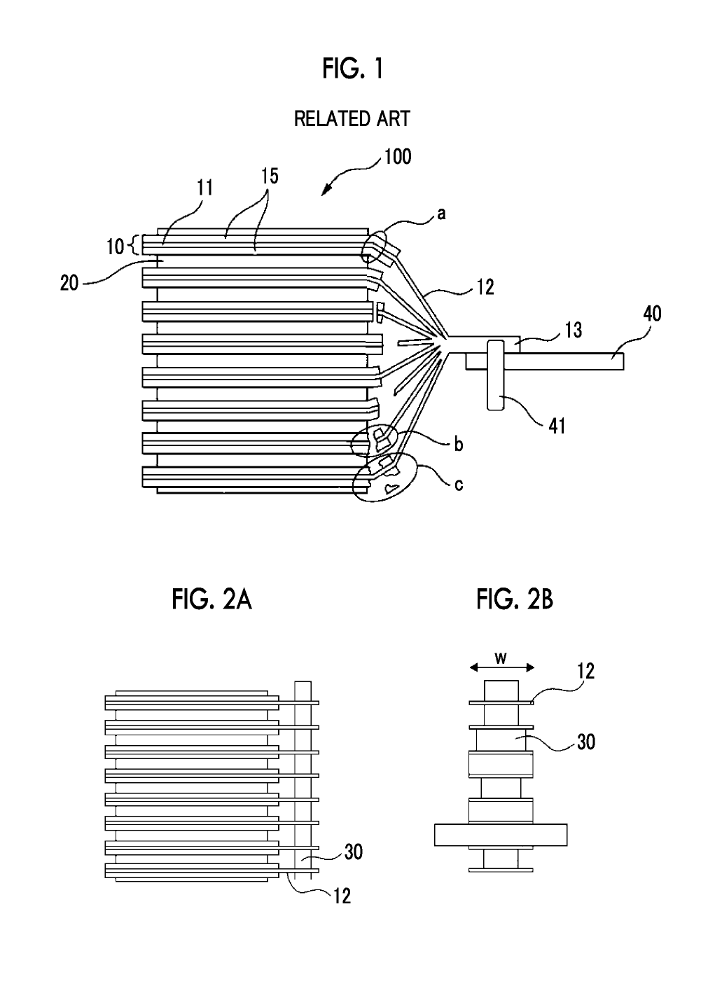

### DETAILED DESCRIPTION OF EMBODIMENTS

An embodiment of a layered cell of the present disclosure will be described in detail.

[Entire configuration of layered cell]

The layered cell of the embodiment is a layered cell obtained by stacking a plurality of unit cells, each having a positive electrode having a positive electrode current collector layer, a negative electrode having a negative electrode current collector layer, and a solid electrolyte layer disposed between the positive electrode and the negative electrode.

The stacked number of unit cells in the layered cell of the embodiment is the number of the stacked unit cells, which is about two to several hundred.

The positive electrode current collector layer has a positive electrode current collector tab protruding from the positive electrode current collector layer in a surface direction of the positive electrode current collector layer, and the negative electrode current collector layer has a negative electrode current collector tab protruding from the negative electrode current collector layer in a surface direction of the negative electrode current collector layer. It is preferable that, when a stacked structure of the layered cell of the embodiment is observed in the stacking direction, the plurality of positive electrode current collector tabs included in a plurality of positive electrode current collector layers appear to overlap each other at substantially the same position with and have substantially the same size. The plurality of negative electrode current collector tabs included in the plurality of negative electrode current collector layers are also the same as described above. In the embodiment, the plurality of positive electrode current collector tabs and the plurality of negative electrode current collector tabs do not overlap each other in the stacking direction, and the plurality of positive electrode current collector tabs are disposed at positions spaced apart from the plurality of negative electrode current collector tabs in the surface direction.

In the layered cell of the embodiment, a current collector tab that is at least one or preferably both of the positive electrode current collector tab and the negative electrode current collector tab of each of the unit cells is electrically connected to be integrated with the corresponding current collector tab of the neighboring unit cell with intervention of a conductive member disposed in a gap between the current collector tab and the corresponding current collector tab of the neighboring unit cell. In a specific aspect in which the current collector tabs are electrically connected and integrated, a method of manufacturing the layered cell of the embodiment will be described below.

Hereinafter, the embodiment will be described in detail with reference to the accompanying drawings according to necessity.

[Conductive Member]

A conductive member of the embodiment is disposed in a gap between the current collector tabs of neighboring unit cells, and has a function of electrically connecting and integrating the current collector tabs via the conductive member.

A material that constitutes the conductive member is not particularly limited as long as the conductive member has conductivity and can be integrated with the positive electrode current collector tab or the negative electrode current collector tab. Since the layered cell of the present disclosure is a solid cell using a solid electrolyte layer, a degree of freedom of material selection is high because there is no corrosion problem of the metal material due to the electrolyte.

As a specific example of the material that constitutes the conductive member, aluminum is preferably used in the conductive member for the positive electrode when the positive electrode current collector layer is formed of aluminum, copper is preferably used in the conductive member for the negative electrode when the negative electrode current collector layer is formed of copper, and further, for example, materials having a low electrical resistance such as gold, silver, iron, copper, aluminum, or the like, may be appropriately selected and used for the positive electrode and the negative electrode.

A shape of the conductive member may be, for example, a plate shape, a wire shape, a ribbon shape, or the like, and further, the conductive member may be formed in an arbitrary shape using, for example, a conductive assistant-containing adhesive agent or the like, and used.

The conductive member may be individually disposed in a gap between neighboring current collector tabs or two conductive members may be disposed in the gap.

A thickness of the conductive member may be set such that neighboring current collector tabs (the positive electrode current collector tabs or the negative electrode current collector tabs) can conduct electrically without excessive folding. A thickness of the conductive member when the conductive member is individually disposed in the a gap between the neighboring current collector tabs is preferably, specifically, 0.5 times or more, 0.7 times or more, 0.8 times or more, or 0.9 times or more, and 1.5 times or less, 1.3 times or less, 1.2 times or less, or 1.1 times or less, the gap between the neighboring current collector tabs, or may be substantially equal to the gap between the current collector tabs.

Thicknesses of the two conductive members disposed in one gap between the neighboring current collector tabs is preferably set such that a sum of the thicknesses of the conductive members is preferably within a range of that in the case in which the conductive member is individually disposed in one gap between the neighboring current collector tabs. More preferably, two conductive members each having a thickness corresponding to about a half of the gap between the neighboring current collector tabs are used.

The conductive member may be disposed at any one of between the positive electrode current collector tabs and between the negative electrode current collector tabs or may be disposed at both sides.

FIGS. 2A and 2B show an example of the layered cell of the embodiment. FIG. 2A is a front schematic view of the layered cell and FIG. 2B is a side schematic view of the cell of FIG. 2A when seen from a rightward direction in the drawing.

In the layered cell of FIGS. 2A and 2B, conductive members 30 are disposed in gaps between current collector tabs 12 neighboring each other in the stacking direction one at a time, and a thickness of each of the conductive members 30 is substantially the same as the gap (FIG. 2A). Here, the thickness is a size in the stacking direction.

A width w of the conductive member 30 may be substantially the same as, may be smaller than or may be larger than that of the current collector tab 12. FIG. 2B shows that measurement directions of the widths w of the current collector tab 12 and the conductive member 30 are matched. The width w is a size in a direction perpendicular to a direction in which the current collector tab 12 protrudes and the stacking direction of the unit cells.

The width w of the conductive member 30 may be, for example, 40% or more, 50% or more, or 60% or more, and may be 500% or less, 300% or less, or 250% or less of the width of the current collector tab 12. While the width w of the conductive member 30 is substantially the same as the width of the current collector tab 12, when the width w is smaller than the width, the width w of the conductive member 30 may be 100% or less, 90% or less, or 80% or less of the width of the current collector tab 12. When the width w of the conductive member 30 is larger than the width of the current collector tab 12, the width w of the conductive member 30 may be 110% or more, 150% or more, or 200% or more of the width of the current collector tab 12.

The widths of the conductive members 30 in the one layered cell shown in FIG. 2B may be different from each other, or all the widths of the conductive members 30 may be substantially the same.

While a depth of the conductive member disposed in the gap between the neighboring current collector tabs (a length in a direction in which the current collector tab protrudes on the same surface as that of the current collector tab in contact with the conductive member) is substantially the same as the depth of the current collector tab, the depth of the conductive member is preferably smaller than the depth of the current collector tab. The depth of the conductive member may be, for example, 10% or more, 20% or more, or 40% or more, and may be 100% or less, 90% or less, or 80% or less of the depth of the current collector tab. When the conductive member having such a depth is used, reliable conduction between the current collector tabs in the stacking direction of the unit cells can be obtained while preventing short circuiting between the positive electrode current collector tab and the negative electrode and between the negative electrode current collector tab and the positive electrode.

[Tab Lead]

The layered cell of the embodiment may arbitrarily have a tab lead configured to extract current from the electrically connected and integrated current collector tab and conductive member to the outside. A disposition location and a size of the tab lead is arbitrary within a range in which the current can be extracted to the outside via the tab lead. The tab lead can have a shape and a size and be configured to function as a lead to the outside at a position at which electrical conduction to, for example, at least one of the current collector tab and the conductive member can be obtained. While the tab lead typically has a rectangular shape, one end thereof is electrically connected to at least one of the current collector tab and the conductive member, and the other end extends toward the outside of the cell, it is not limited to this aspect.

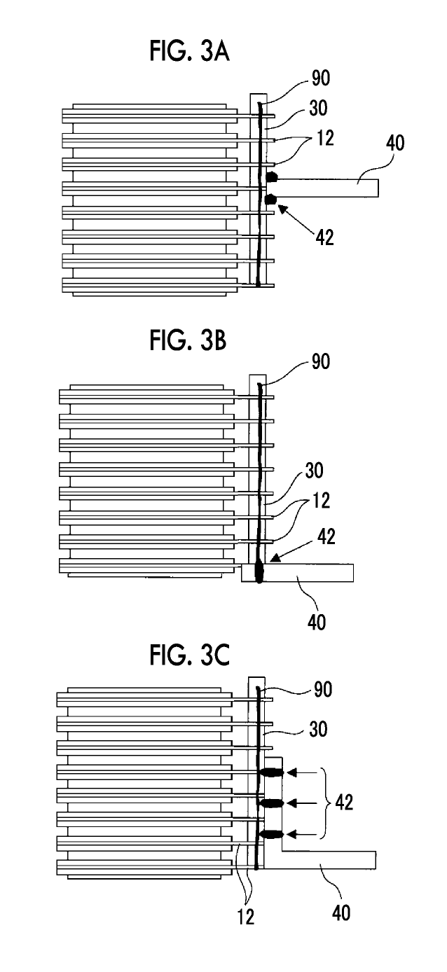

FIGS. 3A to 3C show an example of an aspect in which the layered cell of the embodiment has a tab lead.

A tab lead 40 of the layered cell may be constituted by a member extending in a direction perpendicular to the stacking direction of the layered cell (FIG. 3A and FIG. 3B), or may be constituted by an “L”-shaped member having a portion extending in a direction perpendicular to the stacking direction of the layered cell and a portion extending in a direction parallel to the stacking direction of the layered cell (FIG. 3C).

The tab leads 40 may be joined with intervention of one or a plurality of joining sections 42 in a substantially central portion or an end portion in the stacking direction of the unit cells. When the layered cell to which the tab lead is joined is provided by such a method, extraction of the current to the outside becomes easier.

In the layered cell of FIGS. 3A to 3C, a length of a portion of the tab lead 40 extending in a direction perpendicular to the stacking direction of the unit cells may be, for example, 5 mm or more and 100 mm or less. A length of the tab lead 40 of the layered cell of FIG. 3C extending in the stacking direction of the unit cells (a length of a portion corresponding to a vertical bar of the L shape) may be 5% or more and 100% or less of the height of the layered cell.

Reference numeral 90 in FIGS. 3A to 3C designates a welded section (a bead) in which the current collector tabs are electrically connected and integrated with each other with intervention of the conductive member.

While the conductive member may be used as the lead even when the width of the conductive member is larger than that of the current collector tab, in this case, the current is extracted to the outside preferably in combination with use of the tab lead.

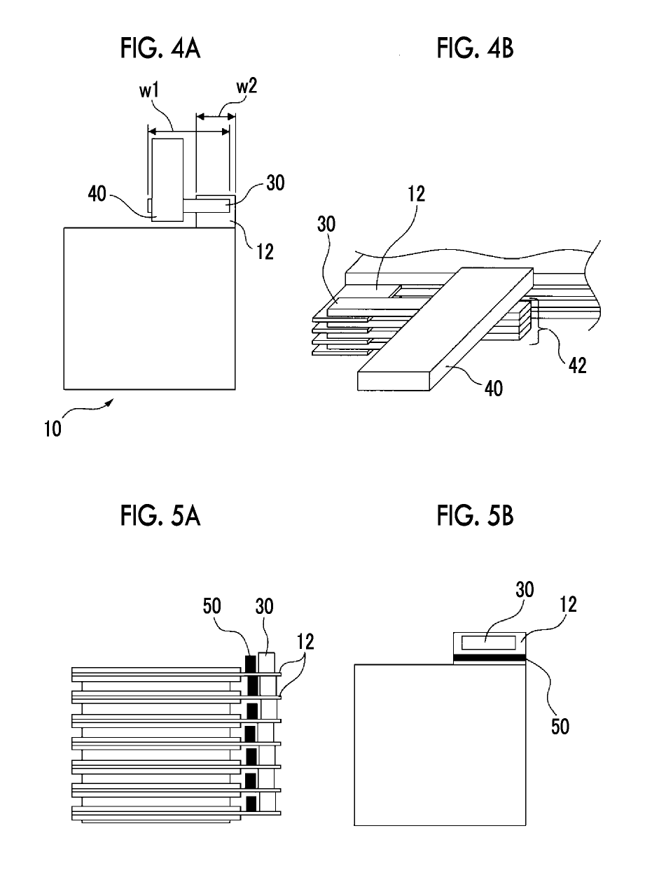

FIGS. 4A and 4B show another example of the aspect in which the layered cell of the embodiment has a tab lead.

FIG. 4A is a schematic plan view of the layered cell when seen from the stacking direction of the unit cells. In the layered cell of FIG. 4A, the width w1 of the conductive member 30 is significantly larger than the width w2 of the current collector tab 12, and the conductive member 30 protrudes outward from the current collector tab 12. Then, the tab lead 40 is joined to a portion of the conductive member 30 protruding from the current collector tab 12. The tab lead 40 extends outward in a direction perpendicular to the stacking direction of the unit cells.

FIG. 4B is a partially enlarged perspective view of a joining region between the conductive member 30 and the tab lead 40 in the layered cell of FIG. 4A. In FIG. 4B, an end portion of the conductive member 30 joined to one end of the current collector tab 12 and protruding from the width w2 of the current collector tab 12 is integrated with the joining sections 42 and joined to the tab lead 40.

In the layered cell of FIGS. 4A and 4B, a length of a portion of the tab lead 40 extending in a direction perpendicular to the stacking direction of the unit cells may be, for example, 5 mm or more and 100 mm or less.

A merit of the layered cell according to the configuration of FIGS. 4A and 4B is that extraction of the current to the outside is easy and further deterioration of cell performance due to the joining processing is suppressed. That is, when the tab lead is joined to at least one of the current collector tab and the conductive member by, for example, welding, the active material layer in the vicinity of the joining area deteriorates due to a large amount of heat applied to the joining area. However, in the layered cell according to the configuration of FIGS. 4A and 4B, since joining processing can be performed at a position spaced apart from an active material layer forming region and a load transmitted to the active material layer during joining can be reduced, the above-mentioned inconvenience is avoided.

The tab lead in the embodiment may be formed of the same material as the that of conductive member.

[Insulating Member]

The layered cell of the embodiment may arbitrarily have an insulating member configured to prevent short circuiting of at least one or both of between the positive electrode current collector tab and the negative electrode and between the negative electrode current collector tab and the positive electrode. The insulating member is disposed between the current collector tab and the active material layer.

Since a thickness (a height) of the insulating member secures insulation without inhibition of electrical conduction in the stacking direction of the current collector tab, while the thickness of the insulating member is substantially the same as the thickness of the conductive material, the thickness of the insulating member is preferably smaller than that of the conductive material.

A width of the insulating member in the layered cell may be substantially the same as, may be smaller than or may be larger than that of the current collector tab. A ratio of the width of the insulating member to the width of the current collector tab may be exemplified as having the same values as those within the numerical range of the width of the conductive member.

FIGS. 5A and 5B show an example of a specific aspect in the case in which the layered cell of the embodiment has an insulating member. FIG. 5A is a side schematic view of the layered cell in a direction perpendicular to the stacking direction of the unit cells, and FIG. 5B is a schematic plan view of the layered cell in the stacking direction.

A thickness of an insulating member 50 in the layered cell of FIGS. 5A and 5B is set to be equal to or smaller than the thickness of the conductive member 30 (FIG. 5A). The thickness of the insulating member 50 in this case may be, for example, 50% or more, 60% or more, or 70% or more, and may be 100% or less, 95% or less, or 90% or less of the thickness of the conductive member 30. When both of the thicknesses have such a relation, insulation between the current collector tab 12 and a counter electrode can be reliably achieved without inhibition of electrical conduction between the current collector tabs in the stacking direction of the unit cells.

A width of the insulating member 50 in the layered cell of FIGS. 5A and 5B is set to be substantially equal to that of the current collector tab 12 (FIG. 5B). When both of the widths have such a relation, insulation between the current collector tab 12 and the counter electrode can be preferably reliably achieved.

<Unit Cell>

Each of the unit cells that constitute the layered cell of the embodiment has a positive electrode having a positive electrode current collector layer, a negative electrode having a negative electrode current collector layer, and a solid electrolyte layer disposed between the positive electrode and the negative electrode. The unit cell may be a laminated body having a positive electrode current collector layer having a positive electrode current collector tab, a positive electrode active material layer, a solid electrolyte layer, a negative electrode active material layer, and a negative electrode current collector layer having a negative electrode current collector tab in sequence.

Elements that constitute the unit cell of the embodiment may be known components. For example, the following cases may be exemplified.

[Positive Electrode]

The positive electrode of the embodiment has a positive electrode current collector layer, and may have, typically, a positive electrode active material layer formed on a surface or both surfaces of the positive electrode current collector layer.

(Positive Electrode Current Collector Layer)

The positive electrode current collector layer has a positive electrode current collector tab protruding from the positive electrode current collector layer in the surface direction. The positive electrode current collector tab is preferably installed in a region of the positive electrode current collector layer in which the positive electrode active material layer is not formed, which will be described below. When the positive electrode current collector layer has a rectangular shape, the layer preferably has a shape in which the positive electrode current collector tab protrudes from one side of the rectangular shape to be parallel to the positive electrode current collector layer. In other words, when seen from the stacking direction of the unit cells, a shape constituted by the positive electrode current collector layer and the positive electrode current collector tab may have substantially an “L” shape or substantially a convex shape in which a rectangular shape smaller than the rectangular shape is added to one side of the rectangular shape in which the positive electrode current collector layer is formed.

A size of the positive electrode current collector tab may be arbitrarily set within a range such that sufficient conduction can be secured. For example, a size of about width 20 mm×depth 0.2 mm may be exemplified. Here, the width of the positive electrode current collector tab is a length in a direction parallel to one side of the positive electrode current collector layer from which the current collector tab protrudes, and the depth of the positive electrode current collector tab is a length in a direction perpendicular to one side of the positive electrode current collector layer from which the current collector tab protrudes. The width and the depth of the conductive member, which will be described below, are also lengths in the same direction as described above, respectively.

The positive electrode current collector tab is a portion of the positive electrode current collector layer protruding from the positive electrode current collector layer in the surface direction, and thus, the thickness thereof is preferably the same as that of the positive electrode current collector layer.

The positive electrode current collector tabs are expected to be electrically connected and integrated with each other by sandwiching the conductive member, which will be described below, in the gap between the positive electrode current collector tabs of the unit cell, which are adjacent to each other and stacked, in the layered cell of the embodiment. Accordingly, in the obtained layered cell, the positive electrode current collector tabs included in the plurality of positive electrode current collectors preferably protrude at substantially the same position with substantially the same size as the positive electrode current collector such that gaps configured to sandwich the conductive members are formed.

For example, a foil formed of stainless steel (SUS), Ni, Cr, Au, Pt, Al, Fe, Ti, Zn, or the like may be used as a material that constitutes the positive electrode current collector layer. While a thickness of the positive electrode current collector layer may be, for example, 15 μm, it is not limited thereto.

(Positive Electrode Active Material Layer)

The positive electrode active material layer includes at least a positive electrode active material, and further, preferably contains a solid electrolyte, a binder, and a conductive material.

For example, a known positive electrode active material such as lithium cobaltate or the like may be appropriately used as the positive electrode active material.

As the solid electrolyte in the positive electrode active material layer, a sulfide-based solid electrolyte may be appropriately used, and specifically, for example, a mixture of Li₂S and P₂S₅ (a mixture mass ratio Li₂S:P₂S₅=50:50 to 100:0, in particular, preferably Li₂S:P₂S₅=70:30) may be exemplified.

For example, a fluorine atom containing resin typified by polyvinylidene fluoride (PVDF) or the like may be used as the binder in the positive electrode active material layer.

A known conductive material such as a carbon nanofiber (for example, VGCF manufactured by Showa Denko Co., Ltd. or the like), acetylene black, or the like, may be exemplified as the conductive material in positive electrode active material layer.

A thickness of the positive electrode active material layer is not particularly limited. For example, a range of 0.1 μm or more and 1,000 μm or less may be exemplified as the thickness of the positive electrode active material layer.

[Negative Electrode]

The negative electrode of the embodiment has a negative electrode current collector layer, and may have, typically, a negative electrode active material layer formed on a surface or both surfaces of the negative electrode current collector layer.

(Negative Electrode Current Collector Layer)

The negative electrode current collector layer has a negative electrode current collector tab protruding from the negative electrode current collector layer in the surface direction. In the description related to the positive electrode current collector tab, a configuration, a size, disposition, or the like, of the negative electrode current collector tab is understood by replacing “the positive electrode” with “the negative electrode.”

For example, a foil of such as SUS, Cu, Ni, Fe, Ti, Co, Zn, or the like, may be used as the material that constitutes the negative electrode current collector layer. While the thickness of the negative electrode current collector layer may be, for example, 15 μm, it is not limited thereto.

(Negative Electrode Active Material Layer)

The negative electrode active material layer includes at least a negative electrode active material, and may use, for example, a known negative electrode active material such as graphite or the like.

The negative electrode active material layer may further include a solid electrolyte, a binder and a conductive material, and the above-mentioned materials that can be used in the positive electrode active material layer may be appropriately used.

The thickness of the negative electrode active material layer in the embodiment is not particularly limited. For example, a range of 0.1 μm or more and 1,000 μm or less may be exemplified as the thickness of the negative electrode active material layer.

[Solid Electrolyte Layer]

The solid electrolyte layer of the embodiment is disposed between the positive electrode and the negative electrode.

The solid electrolyte layer includes at least a solid electrolyte, and preferably, further includes a binder.

The above-mentioned materials that can be used in the positive electrode active material layer may be used as the solid electrolyte in the solid electrolyte layer. Butadiene rubber (BR) is preferably used as the binder.

The thickness of the solid electrolyte layer is different according to a type of solid electrolyte that is used, a configuration of a solid cell, or the like, and may be appropriately selected according to purposes. For example, a range of 0.1 μm or more and 1,000 μm or less may be exemplified as a non-limited numerical range, or a range of 0.1 μm or more and 300 μm or less may be preferable.

<Method of Manufacturing Layered Cell>

The method of manufacturing the same does not matter as long as the layered cell of the embodiment has the above-mentioned configuration. For example, the following first manufacturing method and second manufacturing method may be exemplified.

[First Manufacturing Method]

The first manufacturing method of the embodiment is a method of manufacturing a layered cell, the method including preparing a positive electrode, a negative electrode and a solid electrolyte layer (a process (1)), joining a conductive member to one surface of at least one of a positive electrode current collector tab of a positive electrode current collector layer in a positive electrode and a negative electrode current collector tab of a negative electrode current collector layer in a negative electrode (a process (2-1)), stacking the positive electrode, the solid electrolyte layer and the negative electrode and obtaining a cell laminated body formed by stacking a plurality of unit cells each having the positive electrode, the negative electrode and the solid electrolyte layer disposed between the positive electrode and the negative electrode (a process (3)), and joining the conductive member and the current collector tab adjacent to the conductive member through welding, and electrically connecting and integrating at least one of the positive electrode current collector tabs and the negative electrode current collector tabs in the cell laminated body to each other with intervention of the conductive member (a process (4-1)).

Hereinafter, in the first manufacturing method of joining the conductive member to one surface of the current collector tab, a method of manufacturing a layered cell of the embodiment with reference to the accompanying drawings exemplarily using the case in which positive and negative electrodes have active material layers formed on both surfaces of the current collector layer will be described.

(Process (1))

In the process (1), the positive electrode, the negative electrode and the solid electrolyte layer are prepared.

In preparing the positive electrode and the negative electrode, for example, the active material layers can be formed on both surfaces of each of the positive electrode current collector layer and the negative electrode current collector layer. Here, the preparing may be performed by applying an electrode mixture formed by dissolving or dispersing components to be contained in each of the electrode active material layers in an appropriate medium on both surfaces of each of the electrode current collector layers, and drying and compressing the components according to necessity. Here, one end of the current collector layer is left in an uncoated state to form the current collector tab. The formed electrode is wound in, for example, a roll shape and is provided for the next step.

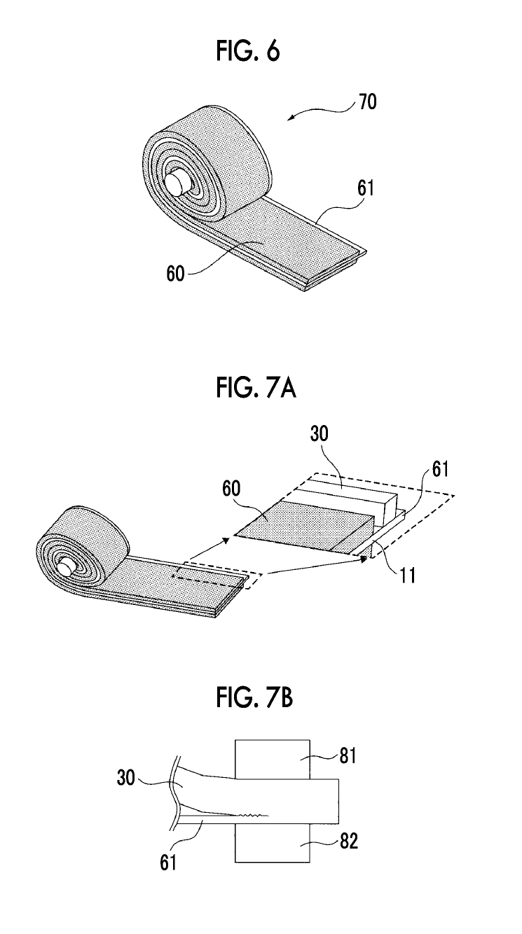

FIG. 6 shows a schematic view for describing an example of the electrode obtained in the process (1). FIG. 6 shows a state in which a first electrode 70 having active material layers 60 formed on both surfaces of the first current collector layer (the positive electrode current collector layer or the negative electrode current collector layer) is wound in a roll shape. The first electrode 70 has an uncoated region 61 having a constant width and formed at one end of the first current collector layer. In the uncoated region 61, the first current collector layer is exposed. A portion of the uncoated region 61 is cut and removed in the next step, and the remaining section functions as the first current collector tab.

The solid electrolyte layer may be obtained by, for example, pressing a mixture obtained by mixing the above-mentioned solid electrolyte and preferably the binder.

(Process (2-1))

Next, in the process (2-1), the conductive member is joined to one surface of at least one of the positive electrode current collector tab of the positive electrode current collector layer in the positive electrode and the negative electrode current collector tab of the negative electrode current collector layer in the negative electrode obtained in the process (1).

FIG. 7A shows a state after the conductive member 30 is joined onto one surface of the uncoated region 61. The joining may be performed by, for example, ultrasonic joining or the like.

FIG. 7B shows an example of the joining method when ultrasonic joining is employed. FIG. 7B shows the case in which ultrasonic joining is performed by moving a gap between a resonant body (a horn) 81, which ultrasonically vibrates, and a clamping jig (an anvil) 82 in a state in which the uncoated region 61 of the electrode and the conductive member 30 overlap.

When the conductive member is joined to one surface of the current collector tab, the thickness of the conductive member is preferably 0.5 times or more and 1.5 times or less the gap between the neighboring current collector tabs or is preferably substantially the same as the gap between the current collector tabs.

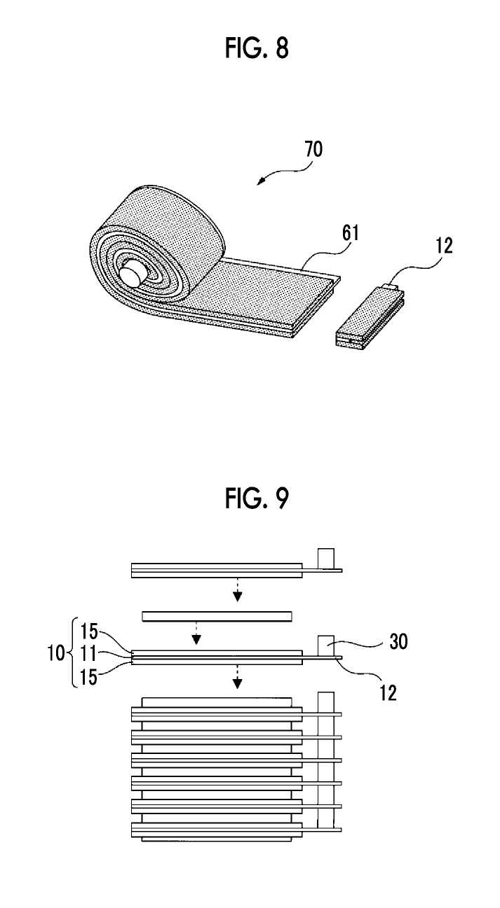

After finishing of the above-mentioned sequence, the first electrode 70 having the conductive member 30 is cut into a predetermined shape (FIG. 8). The uncoated region 61 of the electrode mixture of the first electrode 70 has a predetermined shape as the current collector tab 12 formed by the cutting.

(Process (3))

In the process (3), the positive electrode, the solid electrolyte layer and the negative electrode, which are obtained, are stacked to obtain a cell laminated body formed by stacking a plurality of unit cells each having the positive electrode, the negative electrode, and the solid electrolyte layer disposed between the positive electrode and the negative electrode.

Here, the unit cells may be stacked after the unit cells are formed, or positive electrodes, solid electrolyte layers, and negative electrodes may be stacked to form stacking units without forming separate unit cells, and as a result, a cell laminated body in which a plurality of unit cells are stacked may be obtained.

In order to obtain the cell laminated body, when the unit cells, or the positive electrodes, the solid electrolyte layers and the negative electrodes are stacked, five layers each having the positive electrode current collector layer, the positive electrode active material layer, the solid electrolyte layer, the negative electrode active material layer and the negative electrode current collector layer in sequence may be stacked as a stacking repetition unit such that front and rear surfaces of each unit cell are aligned, or eight layers each having the positive electrode current collector layer, the positive electrode active material layer, the solid electrolyte layer, the negative electrode active material layer, the negative electrode current collector layer, the negative electrode active material layer, the solid electrolyte layer and the positive electrode active material layer in sequence may be stacked as a stacking repetition unit such that front and rear surfaces of each of the neighboring unit cells are reversed with respect to those neighboring.

FIG. 9 shows the case in which a cell laminated body having a plurality of unit cells that are stacked is formed by sequentially stacking the first laminated body 10 having solid electrolyte layers formed on both surfaces of the first electrode (for example, the positive electrode) and the second laminated body 20 formed of the second electrode (for example, the negative electrode) that is a counter electrode of the first electrode without forming unit cells.

(Process (4-1))

Then, in the process (4-1), the conductive member and the current collector tab adjacent to the conductive member are joined, and at least one of the positive electrode current collector tabs and the negative electrode current collector tabs of the cell laminated body are electrically connected and integrated with each other with intervention of the conductive member.

In the electrical connection and integration, for example, end surface joining of joining end surfaces of at least one of the current collector tabs and the conductive member, collective joining of collecting and joining the current collector tabs and the conductive member in the stacking direction of the unit cells, or the like, may be employed.

Welding is employed as the joining method in the case of the end surface joining. Specifically, for example, methods such as laser welding, MIG welding, TIG welding, electron beam welding, or the like, may be employed. The welding in the case of the end surface joining may be, for example, substantially linear welding extending in the stacking direction of the unit cells, substantially linear welding extending in a direction inclined with respect to the stacking direction, or welding having an appropriate shape such as a stripe shape, a vortex shape, a dot shape, an arbitrary curved shape, or the like.

In the case of the end surface joining, a method of joining end surfaces of one, which further protrudes than the other, of the current collector tabs and the conductive members or a method of substantially equalizing protrusion lengths of the current collector tabs and the conductive members and joining both of them may be provided.

A method such as ultrasonic joining, resistance welding, electron beam welding, or the like, may be applied as the joining method in the case of collective joining.

In both of the end surface joining and the collective joining, during joining, when the current collector tabs and the conductive members are collectively clamped in the stacking direction, electrical connection in the stacking direction can be preferably secured without forming a gap between the current collector tab and conductive member.

[Second Manufacturing Method]

A second manufacturing method of the embodiment is a method of manufacturing a layered cell, the method including preparing a positive electrode, a negative electrode and a solid electrolyte layer (a process (1)), joining conductive members to both surfaces of at least one of a positive electrode current collector tab of a positive electrode current collector layer in the positive electrode and a negative electrode current collector tab of a negative electrode current collector layer in the negative electrode (a process (2-2)), stacking the positive electrode, the solid electrolyte layer and the negative electrode and obtaining a cell laminated body formed by stacking a plurality of unit cells each having the positive electrode, the negative electrode and the solid electrolyte layer disposed between the positive electrode and the negative electrode (a process (3)), and joining the neighboring conductive members through welding, and electrically connecting and integrating at least one of the positive electrode current collector tabs and the negative electrode current collector tabs with intervention of the conductive member (a process (4-2)).

(Process (1))

In the second manufacturing method, in the process (1), the positive electrode, the negative electrode and the solid electrolyte layer are prepared. The process may be performed like the process (1) in the first manufacturing method.

(Process (2-2))

In the process (2-2) in the second manufacturing process, the conductive members are joined to both surfaces of at least one of the positive electrode current collector tab of the positive electrode current collector layer in the positive electrode and the negative electrode current collector tab of the negative electrode current collector layer in the negative electrode. The process may be performed like the process (2-1) in the first manufacturing method except that joining of the conductive member is performed on both surfaces of the current collector tab instead of one surface of at least one of the positive electrode current collector tab and the negative electrode current collector tab.

When the conductive member is joined to both surfaces of the current collector tab, the thickness of the conductive member is preferably 0.25 times or more and 0.75 times or less the gap between the neighboring current collector tabs or is preferably about ½ of the gap between the current collector tabs.

(Process (3))

In the second manufacturing method, in the process (3), the positive electrode, the solid electrolyte layer and the negative electrode are stacked to obtain a cell laminated body formed by stacking a plurality of unit cells each having the positive electrode, the negative electrode, and the solid electrolyte layer disposed between the positive electrode and the negative electrode. The process may be performed like the process (3) in the first manufacturing method.

(Process (4-2))

In the second manufacturing method, in the process (4-2), the neighboring conductive members are joined, and at least one of the positive electrode current collector tabs and the negative electrode current collector tabs are electrically connected and integrated with each other with intervention of the conductive member.

The process may be performed pursuant to the process (4-1) in the first manufacturing method except that the conductive members are joined. In the second manufacturing method, in the process (2-2), since the conductive members are joined to both sides of the current collector tab and electrical connection between the current collector tabs and the conductive members is already secured, the current collector tabs and the conductive members can be electrically connected through the layered cell when the conductive members are electrically connected.

The joining method in the process (4-2) of the second manufacturing method may employ the same method as the joining method of the first manufacturing method.

[Joining of Tab Lead]

In the method of manufacturing the layered cell of the embodiment, the tab lead may be arbitrarily joined to the current collector tabs that are electrically joined and integrated as described above.

In joining the tab lead to at least one of the current collector tab and the conductive member, for example, a method such as welding such as laser welding, resistance welding, ultrasonic wave welding, or the like; adhesion by a conductive adhesive agent; or the like, may be provided.

[Another Manufacturing Method]

The layered cell of the embodiment can be manufactured as described above. However, the method of manufacturing the layered cell of the embodiment is not limited thereto. As another method of manufacturing the layered cell of the embodiment, for example, the following aspects may also be exemplified.

A method of manufacturing a layered cell includes: preparing a positive electrode, a negative electrode and a solid electrolyte layer; stacking the positive electrode, the solid electrolyte layer and the negative electrode and obtaining a cell laminated body formed by stacking a plurality of unit cells each having the positive electrode, the negative electrode and the solid electrolyte layer disposed between the positive electrode and the negative electrode; disposing a conductive member in a gap between at least one of positive electrode current collector tabs of a positive electrode current collector layer in the positive electrode and negative electrode current collector tabs of a negative electrode current collector layer in the negative electrode of the cell laminated body obtained as described above, and electrically connecting and integrating at least one of the positive electrode current collector tabs and the negative electrode current collector tabs in the obtained cell laminated body with intervention of the conductive member.

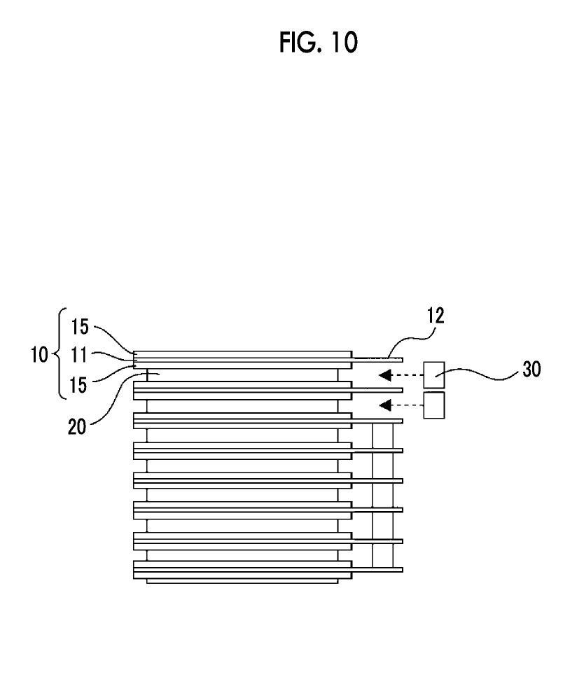

In another method, without going through the process (2-1) or the process (2-2), the electrodes obtained in the same way as described above except that the conductive members are not joined are stacked together with the solid electrolyte layer to obtained the cell laminated body, as shown in FIG. 10, the conductive member is disposed in the gap between the current collector tabs of the cell laminated body, and then, electrical connection and integration of the current collector tabs are performed.

What is claimed is:

1. A layered cell comprising:
a plurality of unit cells each having a positive electrode having a positive electrode current collector layer, a negative electrode having a negative electrode current collector layer, and a solid electrolyte layer disposed between the positive electrode and the negative electrode,
wherein the unit cells are stacked,
the positive electrode current collector layer has a positive electrode current collector tab protruding from the positive electrode current collector layer in a surface direction of the positive electrode current collector layer,
the negative electrode current collector layer has a negative electrode current collector tab protruding from the negative electrode current collector layer in a surface direction of the negative electrode current collector layer, and
a current collector tab that is at least one of the positive electrode current collector tab and the negative electrode current collector tab is electrically connected and integrated with a corresponding current collector tab of a neighboring unit cell with intervention of a conductive member disposed in a gap between the current collector tab and the corresponding current collector tab of the neighboring unit cell.

2. The layered cell according to claim 1, wherein a width of the conductive member in a direction perpendicular to a direction in which the current collector tab protrudes and a direction in which the unit cells are stacked is larger than a width of the current collector tab in the direction perpendicular to the direction in which the current collector tab protrudes and the direction in which the unit cells are stacked.

3. The layered cell according to claim 2, further comprising:
a lead joined to a portion of the conductive member protruding from the current collector tab.

4. The layered cell according to claim 1, wherein each of both the positive electrode current collector tab and the negative electrode current collector tab is the current collector tab.

5. The layered cell according to claim 1, wherein a length of the conductive member in a direction in which the current collector tab protrudes is smaller than a length of the current collector tab in the direction in which the current collector tab protrudes.

6. The layered cell according to claim 1, further comprising:
an insulating member disposed on a surface of the current collector tab and disposed between the conductive member and the unit cell.

7. A method of manufacturing the layered cell according to claim 1, the method comprising:
preparing the positive electrode, the negative electrode and the solid electrolyte layer;
joining the conductive member to one surface of the current collector tab that is at least one of the positive electrode current collector tab and the negative electrode current collector tab;
stacking the positive electrode, the solid electrolyte layer and the negative electrode, and obtaining a cell laminated body formed by stacking the plurality of unit cells each having the positive electrode, the negative electrode, and the solid electrolyte layer disposed between the positive electrode and the negative electrode; and
joining the conductive member and the current collector tab adjacent to the conductive member and electrically connecting and integrating the current collector tab with the corresponding current collector tab of the neighboring unit cell with intervention of the conductive member.

8. A method of manufacturing the layered cell according to claim 1, the method comprising:
preparing the positive electrode, the negative electrode and the solid electrolyte layer;
joining the conductive members to both surfaces of the current collector tab that is at least one of the positive electrode current collector tab and the negative electrode current collector tab;
stacking the positive electrode, the solid electrolyte layer and the negative electrode and obtaining a cell laminated body formed by stacking the plurality of unit cells each having the positive electrode, the negative electrode, and the solid electrolyte layer disposed between the positive electrode and the negative electrode; and
joining the neighboring conductive members and electrically connecting and integrating the current collector tab with the corresponding current collector tab of the neighboring unit cell with intervention of the conductive member.

9. The method of manufacturing the layered cell according to claim 7, wherein joining of the current collector tab and the conductive member is performed by ultrasonic joining.

10. A method of manufacturing the layered cell according to claim 1, the method comprising:
preparing the positive electrode, the negative electrode and the solid electrolyte layer;
stacking the positive electrode, the solid electrolyte layer and the negative electrode and obtaining a cell laminated body formed by stacking the plurality of unit cells each having the positive electrode, the negative electrode, and the solid electrolyte layer disposed between the positive electrode and the negative electrode;
disposing the conductive member in the gap between the current collector tab that is at least one of the positive electrode current collector tab and the negative electrode current collector tab and the corresponding current collector tab of the neighboring unit cell; and
electrically connecting and integrating the current collector tab with the corresponding current collector tab of the neighboring unit cell with intervention of the conductive member.
